(19) United States
(12) Patent Application Publication
(10) Pub. No.: US 2026/0237203 A1
(43) Pub. Date: Aug. 13, 2026

(54) METHODS AND SYSTEM FOR VEGETATION DATA ACQUISITION AND APPLICATION

(71) Applicant: CarbonCo Limited, Nelson (NZ)

(72) Inventors: Hannes Till HILLE, Nelson (NZ); Nicholas David BUTCHER, Nelson (NZ); Geoffrey IRONS, Nelson (NZ); Julian Roscoe MACLAREN, Nelson (NZ); Crispin David LOVELL-SMITH, Nelson (NZ); Nick BURNS, Nelson (NZ)

(21) Appl. No.: 19/126,644

(22) PCT Filed: Nov. 1, 2023
(86) PCT No.: PCT/NZ2023/050119

§ 371 Date: May 1, 2025

Related U.S. Application Data
(60) Provisional application No. 63/421,531, filed on Nov. 1, 2022.

(51) Int. Cl. G06V 20/10; A01B 79/00; G01C 21/36; G06T 7/00; G06V 20/13

(52) U.S. Cl. CPC G06V 20/188; A01B 79/005; G01C 21/3602; G01C 21/3647; G06T 7/0012; G06V 20/13; G06T 2207/10032; G06T 2207/30188; G06V 2201/10

(57) ABSTRACT

A method comprising: determining, by a local data capture device, location data, comprising one or more locations; capturing local data at a location, the local data relating to vegetation at the location; obtain remote data, the remote data relating to vegetation at the location; and apply the local data and the remote data.

### FIELD

This relates to methods and a system for vegetation data acquisition and applications of the vegetation data.

### BACKGROUND

There are applications in which it is useful to use data about vegetation or the environment in an area. This can be gathered in a number of ways.

### SUMMARY

In an example embodiment, there is provided a method comprising: determining, by a local data capture device, location data, comprising one or more locations; capturing local data at a location, the local data relating to vegetation at the location; obtain remote data, the remote data relating to vegetation at the location; and apply the local data and the remote data.

### BRIEF DESCRIPTION

The description is framed by way of example with reference to the drawings which show certain embodiments. However, these drawings are provided for illustration only, and do not exhaustively set out all embodiments.

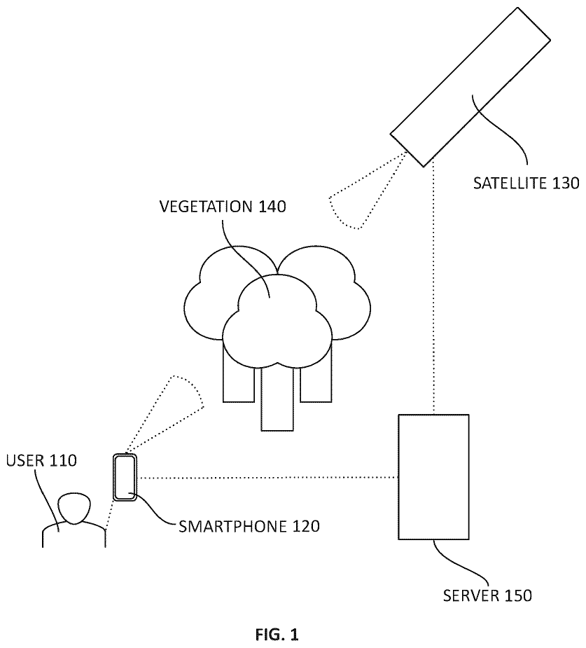

FIG. 1 shows an example use of a system of obtaining vegetation data.

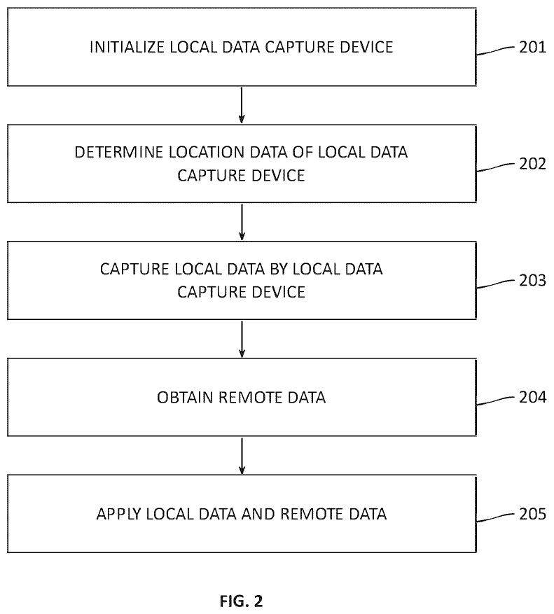

FIG. 2 shows an example method for obtaining and using vegetation data.

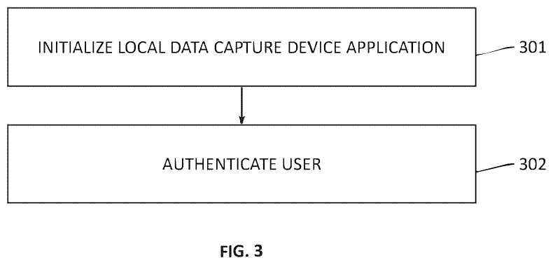

FIG. 3 shows an example method for initializing a local data capture device.

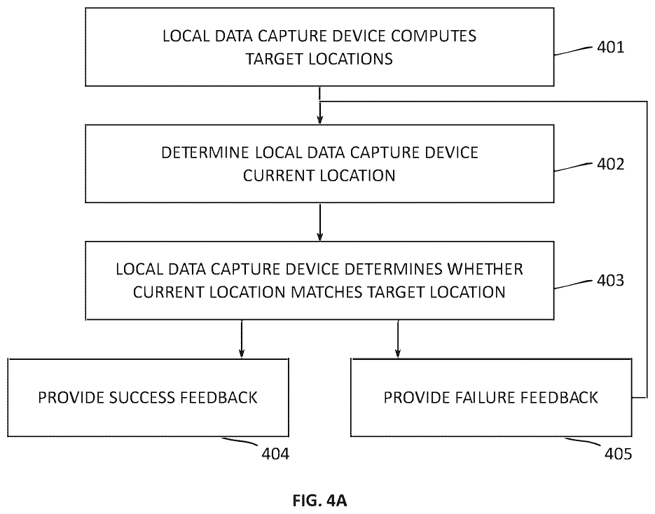

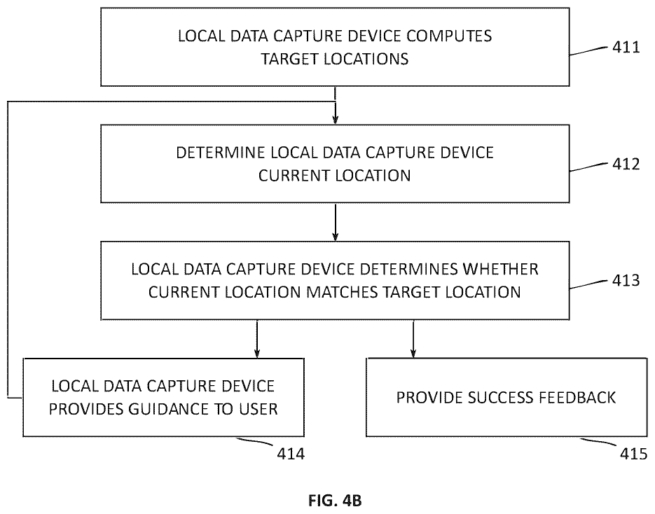

FIG. 4A shows a first example method for capturing local data in which a user's current location is compared to one or more target locations.

FIG. 4B shows a second example method for capturing local data in which a user is provided guidance to reach one or more target locations.

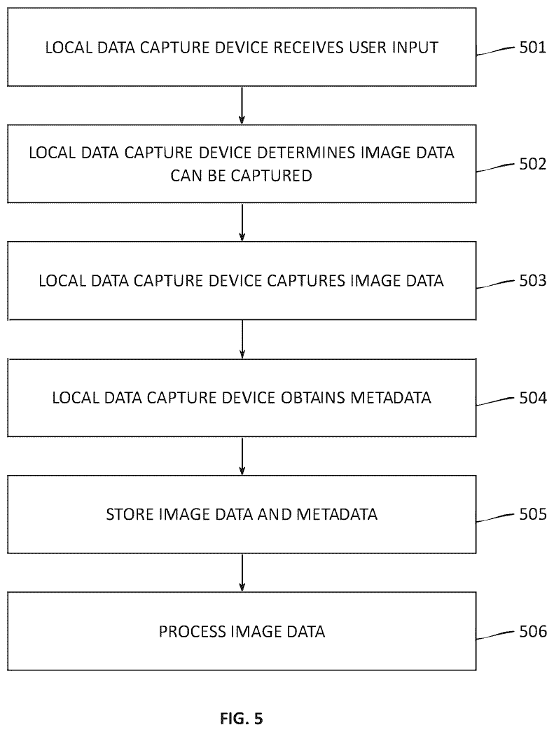

FIG. 5 shows an example method for capturing local data.

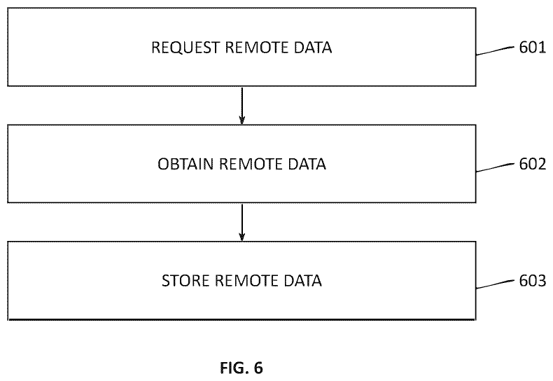

FIG. 6 shows an example method for obtaining remote data.

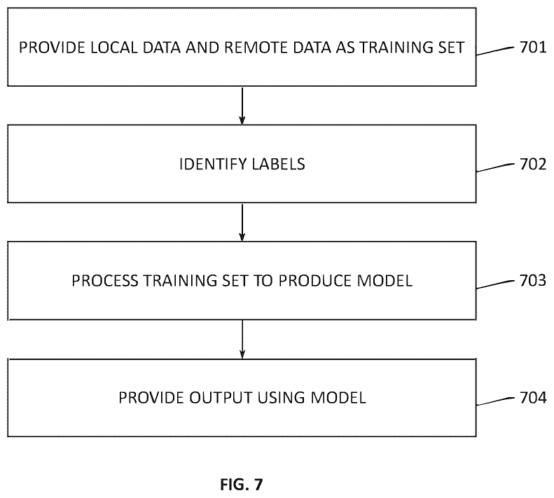

FIG. 7 shows a first example method for applying the local data and the remote data in which a model is produced.

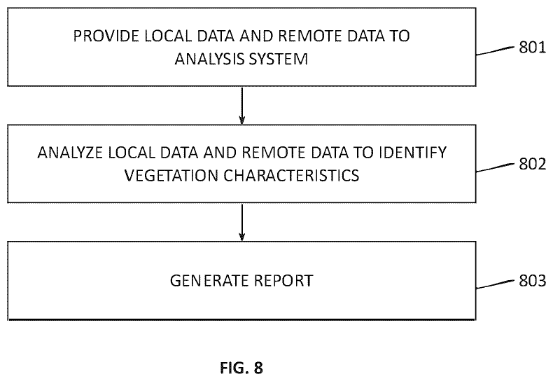

FIG. 8 shows a second example method for local data and the remote data in which a report is produced.

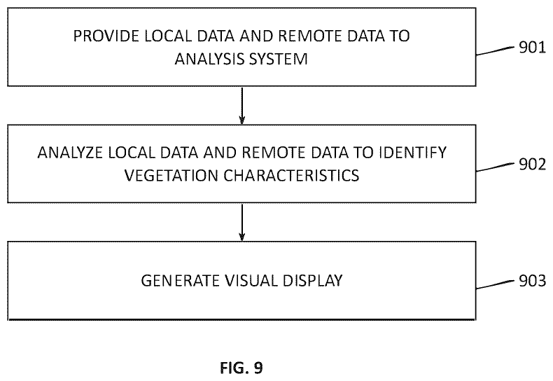

FIG. 9 shows a third example method for local data and the remote data in which a visual display is produced.

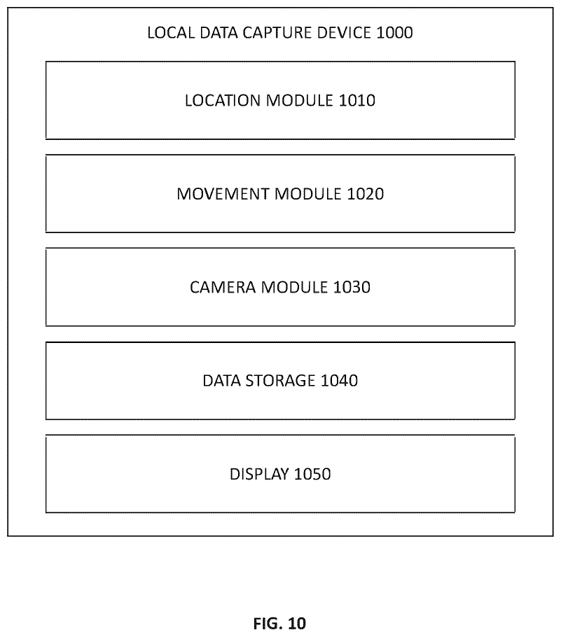

FIG. 10 shows an example local data capture device.

### DETAILED DESCRIPTION

In some applications, it may be useful to gather vegetation data. This vegetation data may be useful to determine the growth or condition of vegetation.

In this case, “vegetation” may comprise any kind of plant, including but not limited to trees and crops. This can occur through obtaining at least two sources of data. These at least two sources of data may be applied to obtain further output, such as carbon sequestration data.

A first source of data may be local data. Local data may comprise at least image data and may further comprise one or more other data points. The image data may be images, video, 3-dimensional surface models derived from other image data, positional sensor data applied to photogrammetry models, or other kinds of image data. This is gathered relatively near the vegetation. In this case, “near” may be less than about 100 meters, or preferably less than about 10 meters. This may be gathered from a handheld device, such as a smartphone.

A second source of data may be remote data. Remote data may comprise at least image data and may further comprise one or more other data points. This is gathered relatively far from the vegetation. In this case, “far” may mean more than 100 meters away, or preferably more than about 1 kilometer away, or preferably more than about 10 kilometers away, or more preferably more than about 100 kilometers away.

In some cases, the local data and remote data may then be used to develop a model.

By using both local data and remote data, this may result in a higher accuracy output than local or remote data alone. In addition, a model developed on this basis may allow for an accurate result to be obtained in an area from the use of one of local or remote data for that area alone in situations where the other is not available.

FIG. 1 shows an example use of a system to this end.

A user 110 operates a local data capture device 120, such as a smartphone, to obtain local data, such as images, about vegetation 140. In addition, remote data is obtained from a remote data source, such as a satellite 130, about the vegetation 140. The local data and remote data are passed to a system 150. The system 150 processes the local data and remote data.

### Obtaining and Using Vegetation Data

FIG. 2 demonstrates an example method for how such an approach may be implemented.

At step 201, a local data capture device is initialized. The local data capture device may be a handheld device, such as a smartphone. In some cases, this may be the device set out in FIG. 10.

Initializing a local data capture device may mean turning on the device. In addition, a particular application may be initialized. For example, an application which is configured to capture images may be initialized.

At step 202, location data of the local data capture device is determined.

The location data may comprise a location of the local data capture device. This may be provided by a location module of the local data capture device. The location module may make use of a global navigation satellite system, such as the Global Positioning System (GPS), the Global Navigation Satellite System (GLONASS), the BeiDou Navigation Satellite System, and Galileo.

The location data may further comprise one or more of an orientation, an angular movement rate, and a linear movement rate of the local data capture device. This may be provided by a movement module of the local data capture device, such as an inertial measurement unit. The inertial measurement unit may comprise accelerometer data along three axes, rotational rate data about three axes, and a three-axis magnetometer.

The location data may further comprise a height of the local data capture device. This may be provided by a height module of the local data capture device, such as an altimeter.

Additionally, or alternatively, the location of vegetation near the local data capture device may be determined. For example, where a local data capture device is positioned to capture an image of some vegetation, the local data capture device may compute the location of the vegetation. The location of the vegetation may be computed in one or more of a plurality of approaches.

In a first approach, the location may be computed based on the local data capture device, for example through the location of the local data capture device, an orientation of the local data capture device, and a calculated or approximate distance between the local data capture device and the vegetation.

In a second approach, the location of the vegetation may be computed by comparing the image to a database of images, each image in the database being associated with a location. By identifying an image in the database of images similar to the captured image, the corresponding location may be used as the location of the captured image. In some cases, the database of images may be normalized, for example through orthorectification.

A combination of the first and second approaches may be used, which may provide a higher level of accuracy.

Additionally, or alternatively, the location of the local data capture device and the vegetation near the local data capture device may be determined either at the time of capture or at a subsequent time through the application of a local environment localization technique. One such technique is the application of a Simultaneous Localization and Mapping (SLAM) algorithm. This may use one or more of the inputs from using one or more of the available sensor inputs. The reference dataset for the application of the SLAM (or similar) algorithm may be either other local data collected in this instance of local data acquisition, or other local data collected from a past instance of local data collection for the same or nearby location.

Additionally, or alternatively, the location of the local data capture device may include recent location data at the time of initialization. This recent location data may comprise the set of locations (and may comprise some of all of the location variables described above) traversed by the device over a preceding period, for example the preceding minute, or ten minutes, or one hour.

In a first example, the recent location data is subsequently applied to improve the accuracy of the estimated location of the local data capture device. That is, based on the recent location data, it may be possible to provide a higher accuracy estimate of the current location of the local data capture device.

In a second example, the recent location information is used to compute the probable veracity of the location information. For example, recent location data should be relatively similar to a current location. In the case of a mismatch, this may indicate data tampering in the location information.

At step 203, local data is captured by the local data capture device.

The local data may comprise one or more images of vegetation. The one or more images may be captured by a camera module of the local data capture device.

The local data may comprise one or more videos of the vegetation, additionally or as an alternative to the one or more images. In some cases, each video comprises a sequence of frames, each frame being an image of the vegetation.

The local data may comprise lidar data. The lidar data may be captured by a lidar module of the local data capture device. The lidar data may be processed to generate a 3-dimensional representation, for example of vegetation.

In some cases, the local data (such as each or multiple of the one or more images) may be stored with metadata. The metadata may comprise all, or a subset of the location data determined at step 202 and/or may comprise a timestamp indicating when the local data was captured. The metadata may further comprise user data corresponding to a user of the local data capture device. This may be stored with the local data in such a way as to prevent or impede subsequent tampering with the metadata, for example through the use of a checksum or signature. For example, each image may be stored with corresponding metadata to indicate where the local data capture device was located when the image was captured, and at what time the image was captured.

At step 204, remote data is obtained.

The remote data comprises one or more images of the vegetation. These may be aerial images, for example captured by aerial photography or satellite. The aerial images may therefore show one or more of a different orientation, zoom level, contrast, and perspective of the vegetation compared to the local data.

The remote data may further comprise metadata. For example, the metadata for each image of the remote data may comprise location data to indicate where the local data capture device was located when the image was captured and at what time the image was captured.

In some cases, the remote data may be obtained by the local data capture device. This may allow the local data capture device to utilize the remote data and the local data in situ.

In other cases, the remote data may be obtained by a separate system, that is, external to the local data capture device. The system may further obtain the local data from the local data capture device.

At step 205, the local data and the remote data is applied. Applying the data may take a number of forms.

In a first example, the local data and the remote data is applied as part of developing a vegetation model. The local data and the remote data are combined to develop an artificial intelligence system. The artificial intelligence system can then be applied to receive as an input one of local data and remote data, and compute, as an output, the other of the two as a prediction.

In a second example, the local data and the remote data may be used to generate a report corresponding to the vegetation. The report may comprise data about the vegetation, such as the height of the vegetation, the type of the vegetation, and the amount of carbon sequestered by the vegetation. This may in turn be used to update an overlay. Additionally or alternatively, the report may be generated using the vegetation model noted in the first example.

In a third example, the local data and the remote data can be applied as part of an augmented reality overlay. A user may visualize data about the vegetation, such as the height of the vegetation, the type of the vegetation, and the amount of carbon sequestered by the vegetation. Additionally or alternatively, the report may be generated using the vegetation model noted in the first example.

The method of FIG. 2 therefore demonstrates an approach to obtain high quality vegetation data which can be applied in a number of ways.

### Initializing a Local Capture Device

Step 201 sets out that a local data capture device is initialized. In some cases, this may further comprise authenticating a user.

FIG. 3 demonstrates an example approach for implementing step 201.

At step 301, an application of the local data capture device is initialized.

The application may be an application running in an operating system of the local data capture device. For example, where the local data capture device is a smartphone, the application may be an app obtained from an app store of the smartphone.

At step 302, a user of the application is authenticated.

The purpose of authentication is to ensure that the user of the local data capture device is known. This may be useful to prove or verify the origin of the captured local data, and allow differentiation between data sourced from trusted vs untrusted users, or to retrospectively invalidate data captured by a user subsequently revealed to be untrustworthy.

Authentication may occur through the provision of a secret, such a password. This may be compared to an internal or external credential store (relative to the local data capture device) to confirm that the secret provided by the user is the secret that is expected to be provided by the user. In preferred cases, an internal credential store may be used to allow authentication without access to external systems. Such an internal credential store may make use of encrypted storage on the local data capture device to allow for authentication without storing plaintext credentials.

Additionally, or alternatively, authentication may occur through the provision of biometric data, such as a fingerprint or image of the user's face. This may be compared to an internal or external credential store to confirm that the biometric data provided by the user is the biometric data that is expected to be provided by the user.

In response to a successful authentication, user data for the authenticated user may be included in metadata for local data captured by the local data capture device.

This may assist in compliance with regulatory requirements and may further be useful to ensure that local data was obtained correctly and reliably. Local data collection may optionally be prohibited in the absence of successful user authentication, or saved for subsequent review and acceptance following a future successful authentication.

In some cases, step 302 may be omitted. This may occur in particular where there is regarded as no need to verify who a user is. This may be where the chance of fraud is sufficiently low or inconsequential.

### Determining Location Data

Step 202 sets out that location data of the local data capture device is determined. In some cases, this may include determining the appropriateness of a location and/or providing guidance to a user as to the correct location to ensure that local data is captured in the right location.

FIG. 4A demonstrates a first example approach for implementing step 202 in which a user's current location is compared to one or more target locations.

At step 401, the local data capture device computes one or more target locations. The target locations may be locations at which local data should be captured.

In some cases, the target locations may be calculated based on the need for a representative sample of locations. Representative may mean spatially representative across an area, or vegetation-wise representative relative to different types of vegetation in the area. This can ensure that local data can be extrapolated across a whole area accurately.

The target locations may additionally or alternatively be calculated based on the accessibility of the location. For example, a location which is inaccessible (such as a sheer cliff) may be omitted. This may be dependent on the method of movement of the user of the local data capture device, as a vehicle may have a different accessibility profile from a person on foot.

The target locations may additionally or alternatively be computed based on the variability and/or novelty of the data that could be gathered, such as vegetation. For example, if the vegetation at a location is unknown, it may be determined that local data should be captured at that location. In a further example, if the vegetation in an area is highly variable, a denser collection of locations may be needed to avoid missing vegetation.

The target locations may further comprise locations for which remote data and/or previous local data is available. This may be useful where repeated image data from the same location is useful.

In some cases, step 401 may be implemented by using a set of predetermined locations. For example, where appropriate locations are known in advance (such as through previous uses of the system, it may be beneficial to repeat the same locations. This can assist in comparing data over time. As another example, initial locations may be predetermined from pre-existing remote data and other information such as sampling guidelines.

In some cases, a user may select a subset (which is preferably one) of the above-calculated target locations as a target location of interest. This may allow a user to influence which of the target locations are prioritized.

In some cases, the one or more target locations may be revised in view of further information received at a target location (such as local data capture). For example, if the conditions at a target location at the time of local data capture are not as they were expected and the target location is therefore reduced in relevance or applicability, the local data capture device may update the one or more target locations based on local data, or calculate one or more new target locations, or may select from a pre-prepared list of alternative target locations. For example, if on arrival at a target location it is evident that vegetation has been lost to a fire, the local vegetation (post-fire) data should be collected but the local data capture device may also recommend an additional local data capture location based on predetermined rules to establish sufficient vegetation growth data from an area not exposed to fire.

At step 402, a current location of the local data capture device is determined. This may be provided by a location module of the local data capture device. The location module may make use of a global navigation satellite system, such as the Global Positioning System (GPS), the Global Navigation Satellite System (GLONASS), the BeiDou Navigation Satellite System, and Galileo.

In some cases, the current location may be calculated based on local data. This may further rely on target location data, such as maps or known images of a target location. For example, the local data may be compared to the target location data to calculate a location and/or an orientation relative to the target location data, for example showing the change from the target location data in six degrees of freedom.

In some cases, this may involve the application of simultaneous localization and mapping approaches and/or dead reckoning approaches.

At step 403, the local data capture device determines whether the current location matches one of the target locations.

Where a target location of interest has been specified, the local data capture device may specifically determine whether the current location matches the target location of interest.

This may involve a threshold distance. That is, if the distance between the current location and a target location is beneath a threshold, the current location may be considered to match one of the target locations. In some cases, the threshold may be less than about 10 meters, or preferably less than about 1 meter. The target location may further be evaluated in six degrees of freedom to consider not only the location but also orientation. In some cases, the orientation may be required to be within a threshold tolerance, for example less than about 10 degrees from a reference orientation, for one, two, or all three axes.

Additionally or alternatively, this may be determined by comparing the image to one or more reference images. This may indicate whether the location and/or orientation is correct.

At step 404, in response to the local data capture device determining that the current location matches one of the target locations, the local data capture device may provide feedback to the user to indicate success. For example, the feedback may comprise one or more of visual, audio, or tactile feedback. In some cases, this feedback may be omitted.

The local data capture device may then proceed to step 203. In some cases, following the subsequent capture of local data, the target location corresponding to the current location may be removed from the set of one or more target locations, and/or the status of a local data capture task for that target location may be updated to “complete”. That is, once local data is captured, the user need not capture further local data at the same location.

At step 405, in response to the local data capture device determining that the current location does not match one of the target locations, the local data capture device may provide feedback to the user to indicate failure. For example, the feedback may comprise one or more of visual, audio, or tactile feedback. The feedback may be configured based on the distance to the target location. For example, audio feedback may repeat slower as the distance increases. In some cases, this feedback may be omitted.

The local data capture device may then revert to step 402. This may occur after a delay, such as about 15 seconds, although preferably will require less than one second so as to provide a fast feedback loop of location evaluation and user correction until the correct location is achieved. In some cases, the local data capture device may prevent the user from proceeding to step 203 until the current location matches one or the target locations.

The approach of FIG. 4A therefore allows a user to ensure that they are at a target location.

FIG. 4B demonstrates a second example approach for implementing step 202 in which a user is provided guidance to reach one or more target locations.

At step 411, the local data capture device computes one or more target locations. The target locations may be locations at which local data should be captured.

In some cases, the target locations may be calculated based on the need for a representative sample of locations. Representative may mean spatially representative across an area, or vegetation-wise representative relative to different types of vegetation in the area. This can ensure that local data can be extrapolated across a whole area accurately.

The target locations may additionally or alternatively be calculated based on the accessibility of the location. For example, a location which is inaccessible (such as a sheer cliff) may be omitted. This may be dependent on the method of movement of the user of the local data capture device, as a vehicle may have a different accessibility profile from a person on foot.

The target locations may additionally or alternatively be computed based on the variability and/or novelty of the data that could be gathered, such as vegetation. For example, if the vegetation at a location is unknown, it may be determined that local data should be captured at that location. In a further example, if the vegetation in an area is highly variable, a denser collection of locations may be needed to avoid missing vegetation.

The target locations may further comprise locations for which remote data and/or previous local data is available. This may be useful where repeated image data from the same location is useful.

In some cases, step 411 may be implemented by using a set of predetermined locations. For example, where appropriate locations are known in advance (such as through previous uses of the system), it may be beneficial to repeat the same locations. This can assist in comparing data over time.

At step 412, a current location of the local data capture device is determined. This may be provided by a location module of the local data capture device. The location module may make use of a global navigation satellite system, such as the Global Positioning System (GPS), the Global Navigation Satellite System (GLONASS), the BeiDou Navigation Satellite System, and Galileo.

In some cases, the current location may be calculated based on local data. This may further rely on target location data, such as maps or known images of a target location. For example, the local data may be compared to the target location data to calculate a location and/or an orientation relative to the target location data, for example showing the change from the target location data in six degrees of freedom.

In some cases, this may involve the application of simultaneous localization and mapping approaches and/or dead reckoning approaches.

At step 413, the local data capture device determines whether the current location matches one of the target locations.

This may involve a threshold distance. That is, if the distance between the current location and a target location is beneath a threshold, the current location may be considered to match one of the target locations. In some cases, the threshold may be less than about 10 meters, or preferably less than about 1 meter. The target location may further be evaluated in six degrees of freedom to consider not only the location but also orientation. In some cases, the orientation may be required to be within a threshold tolerance, for example less than about 10 degrees from a reference orientation, for one, two, or all three axes.

Additionally or alternatively, this may be determined by comparing the image to one or more reference images. This may indicate whether the location and/or orientation is correct.

At step 414, the local data capture device provides the user with guidance towards the one or more target locations.

In one example, the guidance comprises a set of directions. The directions may be map directions (for example, comprising a walking path or road that the user should take). This may additionally or alternatively comprise image guidance, such as of geographical features that a user might use for navigation.

The directions may be provided in a user interface of the local data capture device, for example, where the local data capture device is a smartphone. The directions may be integrated into a map application on the local data capture device.

Step 414 may be repeated continuously or periodically. For example as a user moves, the directions may be revised in view of the user's changing position. This may involve the application of simultaneous localization and mapping approaches and/or dead reckoning approaches.

At step 415, in response to the local data capture device determining that the current location matches one of the target locations, the local data capture device may provide feedback to the user to indicate success. The user interface of the local data capture device may be updated to show that the current location matches a target location. Additionally or alternatively, the feedback may comprise one or more of visual, audio, or tactile feedback. In some cases, this feedback may be omitted.

The local data capture device may then proceed to step 203. In some cases, following the subsequent capture of local data, the target location corresponding to the current location may be removed from the set of one or more target locations. That is, once local data is captured, the user need not capture further local data at the same location.

The approach of FIG. 4B therefore allows a user to be guided to a target location.

### Capturing Local Data

Step 203 sets out that local data is captured by the local data capture device.

FIG. 5 demonstrates an example approach for implementing step 203.

At step 501, the local data capture device receives user input.

The user input is an indication that the user wishes to capture image data. This may comprise the actuation of a user input widget, such as a button, in a user interface. The user input may alternatively be the preconfiguration of the device into a state such that local data is captured as soon as the location is suitable, meaning the device will automatically proceed to (and pause at) step 502 until the location is appropriate.

At step 502, the local data capture device determines that image data can be captured.

In some cases, the local data capture device may only acquire image data when the location data was appropriate. For example, this may require that the location was in a target location and that the orientation is appropriate. In some cases, step 502 may be omitted.

In the event that the location is not appropriate such as that the current location or orientation no longer matches the target location or orientation, local data capture may optionally either pause, or the device may provide an appropriate message of failure to the user and return to step 501 awaiting user input.

At step 503, the local data capture device captures image data.

Preferably, the image data is of vegetation. In some cases, if vegetation is not present in the image data, the image data may be discarded. In other cases, the image data may be retained even if there is no vegetation present. Such data may then be used for the development of a model. This may occur selectively if the retention of such non-vegetation image data can be used for such model development.

The image data may comprise one or more images. These may be captured by a camera module of the local data capture device. The images may be sequential. In cases where the local data capture device has multiple camera modules (for example, multiple lenses), multiple images may be captured at the same time from different camera modules. The image data may additionally or alternatively comprise one or more videos. In some cases, each video comprises a sequence of frames, each frame being an image.

In some cases, the image data may comprise lidar data. The lidar data may be captured by a lidar module of the local data capture device. The lidar data may be captured by a module present on the local data capture device, and may be captured at the same time as images or videos. The lidar data may be processed to generate a 3-dimensional representation, for example of vegetation.

At step 504, the local data capture device obtains metadata corresponding to the image data. The metadata may comprise one or more of location data, time data, user data, sensor data, and audit data. This data may be captured at the same time as the image data of step 503.

The location data comprises data relating to the location of the local data capture device and/or of the subject of the image data (such as vegetation). In some cases, this may be all or a subset of the data determined at step 202. More particularly, the location data may comprise one or more of:
A location of the local data capture device, for example as measured through one or more global navigation satellite systems;
An orientation of the local data capture device, for example as measured by one or more orientation sensors;
An angular movement rate of the local data capture device, for example as measured by one or more gyroscopes;
A linear movement rate of the local data capture device, for example as derived from data measured by one or more accelerometers; and
A height of the local data capture device, for example as measured by one or more altimeters.

The time data comprises data relating to the time at which the image data was captured. The time data may comprise a timestamp for the corresponding image data.

The user data comprises data relating to the user of the local data capture device. More particularly, the user data may comprise one or more of:
an identity of the user;
a Time of Authentication of the User; and
a signature relating to authentication of the user, computed so as to enable verification of the unique combination of associated local data for example through the calculation of a hash of the associated data and signing of that hash with a locally held private key associated with (and accessible only to) the authenticated user.

The sensor data comprises data relating to environmental conditions around where the image data was obtained. These may reflect growing conditions of the vegetation. In particular, the sensor data may comprise one or more of:
ambient light levels;
ambient temperature;
barometric pressure; and
relative humidity.

The audit data comprises data relevant to proving the veracity of the image data and/or other types of metadata. In particular, the audit data may comprise one or more of:
time between locations;
movement paths between locations; and
records of user activity.

In addition to storing individual images and associated location data, this same process may also be used to store time-varying image data (for example, video) and associated time-varying forms of all other location data, including such time information or other alignment mechanism for the referencing of points in time in the video stream to points in time on the location and environment data stream. As an example, video data might be accompanied by, for every frame (or a certain number of frames) in the video, camera location and orientation data.

At step 505, the image data and the metadata are stored.

The image data and the metadata may be stored locally on the local data capture device.

Additionally or alternatively, storing may comprise storing the image data and the metadata in such a way as to prevent or impede subsequent tampering of the image data and/or the metadata. For example, this may involve the use of a checksum or signature.

In some cases, this comprises uploading the image data and the metadata to a server remote from the local data capture device. The server may process the image data and/or the metadata in response to the upload.

At step 506, the image data is processed.

Processing may comprise determining one or more characteristics of the vegetation depicted in the image data. This may comprise identifying one or more of:
dimensions of vegetation;
above-ground biomass of the vegetation; and
species of the vegetation.

In further examples, processing may comprise processing the data for further use. This may comprise one or more of:
stitching together two or more images;
compressing image data and/or associated location and environment data;
adapting and/or developing a model; and
generating a 3-dimensional point cloud or surface model, for example through an algorithm such as structure from motion applied to multiple images and location data, or the direct creation of a 3d point cloud through the application of a suitable AI model to a single image.

In some cases, step 506 may be omitted. For example, it may be determined that processing can be performed later, such as on a remote server. In such a case, the processing on the remote server might involve similar steps as those described for the local data capture device.

Through this approach, local data (comprising image data and metadata) can be captured for use.

### Obtaining Remote Data

Step 204 sets out that remote data is obtained.

FIG. 6 demonstrates an example approach for implementing step 204.

At step 601, remote data is requested.

The remote data may be requested from a remote server. In some cases, the request for the remote data may be based on locations at which local data has been captured and/or is expected to be captured.

The remote data may be requested by the local data capture device. Alternatively, it may be requested by another entity in the system.

At step 602, the remote data is obtained.

Remote data may comprise remote image data. The remote image data may comprise one or more images, preferably of vegetation. These may be aerial images, for example captured by aerial photography or satellite. The aerial images may therefore show a different orientation of the vegetation compared to the local data.

Remote data may alternatively or additionally include one or more of:
lidar data;
synthetic-aperture radar data;
temperature data; and
terrain topology data.

Each of these preferably comprises data relating to the vegetation.

In some cases, the remote data may be captured independently by third party providers of data. In such cases, step 602 may comprise obtaining the data from third party providers.

At step 603, the remote data is stored.

This may be stored locally on a device which performs step 602. Additionally or alternatively, this comprises uploading the remote image data to a server remote from the local data capture device.

In this way, remote data can be requested for later use.

### Applying the Data

Step 205 sets out that the local data and the remote data are applied for one or more purposes. In general, the combination of the local data and the remote data provides a higher quality data source for vegetation than either source in isolation.

FIG. 7 demonstrates a first approach for applying the local data and the remote data, in which a model is produced.

The purpose of the model may be to allow just one of local data and remote data to provide a useful output. The type of output that can be provided may be configured.

At step 701, the local data and the remote data are provided to an artificial intelligence system as a training set.

The artificial intelligence may operate on the local data capture device and/or on a remote server. In some examples, the artificial intelligence system is a neural network, for example a convolutional neural network.

At step 702, the local data and/or the remote data are analyzed to identify one or more labels. The one or more labels relate to characteristics of vegetation in the local data and/or the remote data. In some cases, the labels comprise one or more of:
dimensions of the vegetation;
above-ground biomass of the vegetation;
age of the vegetation;
health of the vegetation;
growth rate of the vegetation;
carbon sequestration of the vegetation; and
species of the vegetation.

In some cases, identifying the one or more labels uses one or more of multiview geometry, SLAM, or pre-determined vegetation model fitting.

In some cases, step 702 may be omitted. For example,

At step 703, the artificial intelligence system processes the training set to produce a model. In some cases, the model may be a convolutional neural network. In a preferred implementation, the vegetation characteristics either directly available in the local data, or determined from post-processing of the local data, are used as labels in a supervised or semi-supervised training process, with the remote data (or other local data) used as the features. The model architecture, training process, and loss functions may be selected such that the accuracy of prediction of the vegetation target characteristic “labels” from a subset of the other remote/local sensing data “features” is maximized for a hold-out set of test features/labels, and generally so as to maximize the accuracy and performance of vegetation characteristic prediction using remote data acquisition methods, for the widest range of vegetation characteristics including those which are generally difficult to directly measure/estimate using remote sensing data alone in the absence of a trained model.

At step 704, the model is used to provide an output.

In a first example, the model is provided with local image data and optionally with metadata for a new location. The model then generates estimated remote image data as an output.

In a second example, the model is provided with remote image data and optionally with metadata for a new location. The model then generates estimated local image data as an output.

In a third example, the model is provided with one or both of local image data and remote image data. The model then calculates a characteristic of the depicted vegetation as an output.

In a fourth example, the model is provided with remote image data only. The model then calculates a characteristic of the depicted vegetation as an output.

Through the use of this model, this can allow for useful outputs to be provided with limited input data.

FIG. 8 demonstrates a second approach for local data and the remote data, in which a report is produced.

At step 801, one or both of the local data and the remote data are provided to an analysis system. The analytics system may comprise one or more of: an artificial intelligence system, such as a neural network, a multiview geometry-based model, a SLAM-based 3-dimensional model, and pre-determined model fitting.

In some cases, the analysis system may rely on one of the local data and the remote data. In these cases, the analysis system may be further supplemented with a model, such as the model produced using the method of FIG. 7.

At step 802, the local data and/or the remote data are analyzed by the analysis system to identify one or more characteristics of the vegetation, comprising one or more of:
dimensions of the vegetation;
above-ground biomass of the vegetation;
age of the vegetation;
health of the vegetation;
growth rate of the vegetation;
carbon sequestration of the vegetation; and
species of the vegetation.

At step 803, the analysis system generates a report.

The report comprises one or more of the characteristics identified at step 802. The report may comprise a user interface, for example provided on the local data capture device and/or on a further device. The characteristics shown in the report may be selected by the user.

This allows a user to obtain characteristics of vegetation in an area.

FIG. 9 demonstrates a third approach for local data and remote data, in which a visual display is produced.

At step 901, one or both of the local data and the remote data are provided to an analysis system. The analytics system may comprise one or more of: an artificial intelligence system, such as a neural network, a multiview geometry-based model, a SLAM-based 3-dimensional model, and pre-determined model fitting.

In some cases, the analysis system may rely on one of the local data and the remote data. In these cases, the analysis system may be further supplemented with a model, such as the model produced using the method of FIG. 7.

At step 902, the local data and the remote data are analyzed by the analysis system to identify one or more characteristics of the vegetation, comprising one or more of:
dimensions of the vegetation;
above-ground biomass of the vegetation;
age of the vegetation;
health of the vegetation;
growth rate of the vegetation;
carbon sequestration of the vegetation; and
species of the vegetation.

At step 903, a visual display is generated.

The visual display may comprise an augmented reality overlay. This is intended to be displayed through an augmented reality headset or other device to allow a user to see the vegetation with additional data and/or with the image data.

The visual display may additionally or alternatively comprise a three-dimensional reconstruction of the vegetation.

### Determining Characteristics

As noted above, characteristics of vegetation may be determined based on the local data and/or the remote data. For example, this may occur as part of step 802 or step 902.

In some cases, this may rely on lidar data. Lidar data measures a distance from a sensor. The lidar data, optionally in combination with vegetation and environment data in the local data, may be used to create a 3-dimensional point cloud.

Alternatively, photogrammetry or remote data comprises one or more multiview geometry techniques may be applied to multiple images in the local data. For example, multiple images of the same scene may be taken, where each image is taken from a slightly different position or at a slightly different angle. By identifying common features in each image, is it possible to solve equations that give the positions of each of those features in 3D space. This, in combination with metadata associated with the local data (such as location and/or orientation) may be used to derived a 3-dimensional point cloud, 3-dimensional surface model, and/or a 3-dimensional object model of the vegetation and/or the surrounding area.

In cases where a 3-dimensional point cloud is generated, this may be processed together with vegetation and environment data in the local data to produce a 3-dimensional surface model, and/or a 3-dimensional object model of the vegetation and/or the surrounding area.

Through these techniques, a 3-dimensional surface model or object model can be generated, for example through use in a visual display.

A 3-dimensional object model may be further processed. For example, object detection and segmentation techniques, for example through the use of an appropriate artificial intelligence system. This may be used, for example, to identify and separate distinct objects with specific vegetation characteristics. For example, this may result in a segmentation based on different tree species.

This may be further supplemented with species-specific, species-family, or generic wood-density or carbon-density reference values to derive values for biomass or carbon sequestration for a given volume of vegetation.

In addition, in the case of trees, species-specific allometric models, for both trunk structure and branch/leaf structure, may be used to predict the attributes and geometries of specific trees based on partial data about those trees. For example, an allometric model may be used which takes as input some or all of the species, estimated or measured crown height, estimated or measured trunk diameter at some point relative to ground (such as diameter at breast height), mean rainfall, mean annual temperature, altitude. Such a model may produce outputs being estimation of for example some or all tree trunk mass, underground biomass, branch/leaf biomass, trunk volume, trunk dimensions, canopy volume, canopy dimensions, and growth rate.

This allows a user to obtain further views or data about vegetation in an area without the need to specifically visit the area.

### System

A local data capture device may be used to perform a number of steps in the methods noted above.

FIG. 10 describes an example local data capture device for implementing the steps.

A local data capture device 1000 may be a device configured to be handheld by a user.

The local data capture device 1000 comprises at least one location module 1010. The location module may make use of a global navigation satellite system, such as the Global Positioning System (GPS), the Global Navigation Satellite System (GLONASS), the BeiDou Navigation Satellite System, and Galileo.

The local data capture device 1000 further comprises at least one movement module 1020, such as an inertial measurement unit.

The local data capture device 1000 further comprises at least one camera module 1030, such as a camera.

The local data capture device 1000 may further comprise at least one lidar module 1040 configured to capture lidar data.

The local data capture device 1000 further comprises data storage 1050 configured to store one or more of local data, remote data, and an application for executing one or more of the steps of the methods noted above.

The local data capture device 1000 further comprises at least one display 1060 configured to display a user interface.

The local data capture device 1000 further comprises at least one processor 1070 configured to execute the application to perform one or more of the steps of the methods noted above.

In some cases, the local data capture device 1000 is a phone, smartphone, or tablet. These may run an operating system such as Android or iOS.

### Interpretation

A number of methods have been described above. Any of these methods may be embodied in a series of instructions, which may form a computer program. These instructions, or this computer program, may be stored on a computer readable medium, which may be non-transitory. When executed, these instructions or this program cause a processor to perform the described methods.

Where an approach has been described as being implemented by a processor, this may comprise a plurality of processors. That is, at least in the case of processors, the singular should be interpreted as including the plural. Where methods comprise multiple steps, different steps or different parts of a step may be performed by different processors.

The steps of the methods have been described in a particular order for ease of understanding. However, the steps can be performed in a different order from that specified, or with steps being performed in parallel. This is the case in all methods except where one step is dependent on another having been performed.

The term “comprises” and other grammatical forms is intended to have an inclusive meaning unless otherwise noted. That is, they should be taken to mean an inclusion of the listed components, and possibly of other non-specified components or elements.

While the present invention has been explained by the description of certain embodiments, the invention is not restricted to these embodiments. It is possible to modify these embodiments without departing from the spirit or scope of the invention.

1. A method comprising:
determining, by a local data capture device, location data, comprising one or more locations;
capturing local data at a location, the local data relating to vegetation at the location;
obtain remote data, the remote data relating to vegetation at the location; and
apply the local data and the remote data.

2. (canceled)

3. The method of claim 1, wherein determining location data comprises:
computing one or more target locations;
determining a current location; and
determining whether the current location matches one of the target locations.

4. The method of claim 3, further comprising:
in response to the local data capture device determining that the current location matches one of the target location, providing feedback to the user to indicate success.

5. The method of claim 3, further comprising:
in response to the local data capture device determining that the current location does not match one of the target location, providing feedback to the user to indicate failure.

6. The method of claim 1, wherein determining location data comprises:
determining a current orientation of the local data capture device; and
determining whether the orientation matches one a target orientation.

7. The method of claim 3, further comprising:
providing guidance towards one or more target locations.

8. The method of claim 1, wherein capturing local data at a location comprises:
capturing image data; and
obtaining metadata corresponding to the image data.

9. The method of claim 8, wherein the metadata comprises a location of the local data capture device and an orientation of the local data capture device.

10. The method of claim 8, further comprising:
determining that image data can be captured.

11. The method of claim 10, wherein determining that image data can be captured comprises:
determining that the location is a target location; and
initializing a local data capture device.

12. The method of claim 8, further comprising:
processing the image data.

13. The method of claim 12, where processing the image data comprises calculating one or more of:
dimensions of vegetation;
above-ground biomass of the vegetation; and
species of the vegetation.

14. The method of claim 1, wherein the remote data comprises aerial images.

15. The method of claim 1, wherein applying the local data and the remote data comprises:
generating a model based on the local data and the remote data.

16. The method of claim 15, further comprising:
using the model to process further remote data without corresponding local data.

17. The method of claim 1, wherein applying the local data and the remote data comprises:
identifying one or more characteristics of vegetation based on the local data and the remote data; and
generating a report based on the one or more characteristics.

18. The method of claim 1, wherein applying the local data and the remote data comprises:
identifying one or more characteristics of vegetation based on the local data and the remote data; and
generating a visual display based on the one or more characteristics.

19. The method of claim 18, wherein the visual display comprises an overlay.

20. The method of claim 19, wherein the overlay comprises one or more of:
height of the vegetation,
the type of the vegetation, and
the amount of carbon sequestered by the vegetation.

21. (canceled)

22. A system configured to implement the method of claim 1.
